(19) United States
(12) Patent Application Publication
(10) Pub. No.: US 2021/0270311 A1
(43) Pub. Date: Sep. 2, 2021

(54) CASING

(71) Applicant: BW Elliott Mfg. Co., LLC, Binghamton, NY (US)

(72) Inventors: Kevin G. Shaw, Binghamton, NY (US); Kevin M. Hause, Binghamton, NY (US); Kenneth Craig Palmer, Binghamton, NY (US)

(21) Appl. No.: 17/187,471

(22) Filed: Feb. 26, 2021

Related U.S. Application Data
(60) Provisional application No. 63/104,602, filed on Oct. 23, 2020.
(60) Provisional application No. 62/983,334, filed on Feb. 28, 2020.

(51) Int. Cl. F16C 1/26; F16C 1/06

(52) U.S. Cl. CPC F16C 1/26; F16C 1/06; F16C 2220/48; F16C 2204/12; F16C 2204/10; F16C 2300/02; F16C 2204/52; F16C 2208/78; F16C 2208/76; F16C 2208/70; F16C 2208/60; F16C 2204/20

(57) ABSTRACT

A casing for a shaft assembly, a shaft assembly, a method of forming a casing, and a drive assembly. The casing may generally include a liner defining a central passage and having a body and an outwardly-extending leg (e.g., extending circumferentially about and/or axially along the body), and a cover extending circumferentially about and axially along the liner.

### RELATED APPLICATIONS

This present application claims the benefit of U.S. Provisional Patent Application No. 62/983,334, filed Feb. 28, 2020, and of U.S. Provisional Patent Application No. 63/104,602, filed Oct. 23, 2020, the entire contents of both of which are hereby incorporated by reference.

### FIELD

This invention generally relates to a casing, for example, for a shaft assembly for a machine, a tool, a device, etc., for use as a tube, pipe, conduit, etc., in agricultural, vehicular, industrial, medical, construction or other applications.

### SUMMARY

Generally, some machines, tools, devices, etc., such as, for example, a concrete vibrator, an agricultural seeder, a valve control, a power tool, an outdoor tool, etc., include a power unit (e.g., a motor, an engine, etc.) coupled to a powered unit (e.g., a vibratory unit, a seed meter, a valve, an output unit, etc.) via a shaft assembly. The shaft assembly may include a flexible or rigid shaft supported for movement (e.g., rotational, sliding, etc.) in a casing. The shaft transmits output from the power unit to the powered unit.

FIGS. 6-7 illustrate existing casings 110 for a shaft assembly. Such a casing 110 includes a liner 130 and a cover 138 with multiple intermediate layers. The illustrated liner 130 is formed of flat spring steel and defines a central passage 142 with an inner diameter D1 of between about 0.425 inches (in.) and about 0.45 in. (e.g., 0.44 in. as illustrated). The inner surface of the liner 130 provides a bearing surface for a shaft (not shown) extending therethrough.

The illustrated cover 138 encompasses the liner 130 and the intermediate layers and provides an outer surface of the casing 110 with an outer diameter D2 of between about 0.95 in. and about 1.15 in. (e.g., about 1.09 in.). To provide an interface at an end of the casing 110, the diameter of the cover 138 may be reduced (e.g., by grinding) to a smaller diameter D3 (e.g., between about 0.95 in. and about 1.05 in. (1.00 in. as illustrated)).

In general, the intermediate layers include a fabric layer 150 (e.g., rubber impregnated fabric) between the outer surface of the liner 130 and a wire braid layer 154 and a rubber layer 158 between the wire braid layer 154 and a textile braid layer 162. In other constructions, different numbers, types, etc. of intermediate layers may be included. For example, as shown in FIG. 7, an additional wire braid layer 166 is positioned between the layers 158, 162.

The illustrated casing 110 has a thickness between the inner surface of the liner 130 and the outer surface of the cover 138. A standard thickness is, at D2, between about 0.30 in. to about 0.35 in. (e.g., about 0.33 in. as illustrated) and at D3, between about 0.27 in. to about 0.30 in. (e.g., about 0.28 in. as illustrated).

The liner 130 has a thickness of between about 14% and about 19% of the thickness of the casing 110 (e.g., about 15.77% at D2 and about 18.29% at D3). The cover 138 shown in FIG. 6 has a thickness of between about 42% and about 52% of the thickness of the casing 110 (e.g., about 51.45% at D2 and about 43.70% at D3). With the additional layer 166, the cover 138 shown in FIG. 7 has a reduced thickness of between about 33% and about 45% of the thickness of the casing 110 (e.g., about 43.49% at D2 and about 34.46% at D3).

The intermediate layers have a thickness of between about 30% and about 50% of the thickness of the casing 110. In the construction of FIG. 6, the layers 150, 154, 158, 162 have a combined thickness of between about 32% and about 39% of the thickness of the casing 110 (e.g., about 32.77% at D2 and about 38.01% at D3). In the construction of FIG. 7, the layers 150, 154, 158, 162, 166 have a combined thickness of between about 40% and about 48% of the thickness of the casing 110 (e.g., about 40.74% at D2 and about 47.24% at D3).

With respect to each individual intermediate layer, the thickness is between about 6% and about 13% of the thickness of the casing 110. However, all but one of the individual intermediate layers have a thickness of less than 8%, at D2, and less than 10%, at D3, of the thickness of the casing 110, with the thickness of the other layer being about 10.70%, at D2, and about 12.43%, at D3, of the thickness of the casing 110.

Because of the number and construction of the layers 150, 154, 158, 162, 166, the existing casing 110 is formed in a batch process to form a casing blank of a given length (e.g., about 60 feet). The construction of the casing 110 is complex, and the resulting manufacturing process is inefficient and labor-intensive.

In use, the casing blank is cut to length to form a number of individual casings 110, each of a selected length (e.g., between about 4 feet long and about 30 feet long), for given applications (e.g., various machines, tools, devices, etc.). Excess lengths of the casing blank become waste.

Due to the complexity of the construction, the interaction of the liner 130, the intermediate layers 150, 154, 158, 162, 166, and the cover 138, etc., it may be difficult to modify the casing 110 and its components to adjust operational characteristics (flexibility, rigidity) based on different applications or to maintain these characteristics while changing components. For example, a change of one intermediate layer (e.g., changing a dimension, characteristic, etc. of the layer, removing the layer) would likely require changes in other layers to maintain the same overall dimensions.

As mentioned above, to provide an interface, the end of the casing 110 may be ground to reduce its outer diameter. With the multiple intermediate layers 150, 154, 158, 162, 166 and the space these layers occupy between the liner 130 and the cover 138, the cover 138 has less material that can be removed before reaching the intermediate layers and the minimum diameter D3 to which the outer surface of the ends can be ground is limited.

In one independent embodiment, a casing, for example, for a shaft assembly for a machine, a tool, a device, etc., for use as a tube, pipe, conduit, etc., in agricultural, vehicular, industrial, medical, construction or other applications, may be provided. The casing may generally include a liner and a cover. The liner may define a central passage and have a body and an outwardly-extending leg. The cover may extend circumferentially about and axially along the liner.

In some constructions, the leg may extend circumferentially about the body and may be spaced axially from a circumferential second leg. In such constructions, the liner may include a corrugated tube providing the body and the legs.

In some constructions, the leg may extend axially along the body and may be spaced circumferentially from an axial second leg. In other constructions, the leg may extend in a combination of circumferentially about and axially along (e.g., as a spiral about and along) the body.

In another independent embodiment, a shaft assembly may generally include a casing and a shaft. The casing may include a liner which may define a central passage and have a body and an outwardly-extending leg (e.g., extending circumferentially about and/or axially along the body), and a cover which may extend circumferentially about and axially along the liner. The shaft may extend through the central passage.

In yet another independent embodiment, a method of forming a casing may be provided. The method may generally include extruding a liner which may define a central passage and have a body and an outwardly-extending leg (e.g., extending circumferentially about and/or axially along the body). The method may also include extruding a cover circumferentially about and axially along the liner.

In a further independent embodiment, a drive assembly may generally include a drive mechanism having a mechanical output; a driven mechanism having a mechanical input; and a shaft assembly. The shaft assembly may include a casing and a shaft. The casing may include a liner defining a central passage and having a body and an outwardly-extending leg (e.g., extending circumferentially about and/or axially along the body), and a cover extending circumferentially about and axially along the liner. The shaft may extend through the central passage. The shaft may be connectable between the drive mechanism and the driven mechanism and may be operable to transmit the mechanical output to the mechanical input.

In another independent embodiment, a casing may generally include a liner defining a central passage and having a body and an outwardly-extending leg (e.g., extending circumferentially about and/or axially along the body); a braided layer extending circumferentially about and axially along the liner, the braided layer engaging the leg; and a cover extending circumferentially about and axially along the braided layer and the liner, the cover engaging the braided layer.

In yet another independent embodiment, a shaft assembly may generally include a casing including a liner defining a central passage and having a body and an outwardly-extending leg (e.g., extending circumferentially about and/or axially along the body), a braided layer extending circumferentially about and axially along the liner, the braided layer engaging the leg, and a cover extending circumferentially about and axially along the braided layer and the liner, the cover engaging the braided layer; and a shaft extending through the central passage.

In a further independent embodiment, a method of forming a casing may be provided. The method may generally include extruding a liner defining a central passage and having a body and an outwardly-extending leg (e.g., extending circumferentially about and/or axially along the body); braiding a braided layer circumferentially about and axially along the liner, the braided layer engaging the leg; and extruding a cover circumferentially about and axially along the liner and the braided layer, the cover engaging the braided layer.

In yet another independent embodiment, a drive assembly for a machine, a tool, a device, etc., may generally include a drive mechanism having a mechanical output; a driven mechanism having a mechanical input; and a shaft assembly. The shaft assembly may include a casing including a liner defining a central passage and having a body and an outwardly-extending leg (e.g., extending circumferentially about and/or axially along the body), a braided layer extending circumferentially about and axially along the liner, the braided layer engaging the leg, and a cover extending circumferentially about and axially along the braided layer and the liner, the cover engaging the braided layer, and a shaft extending through the central passage, the shaft being connectable between the drive mechanism and the driven mechanism and operable to transmit the mechanical output to the mechanical input.

Other independent aspects of the disclosure may become apparent by consideration of the detailed description, claims and accompanying drawings.

### BRIEF DESCRIPTION OF THE DRAWINGS

FIG. 1 is a schematic view of a tool or device, such as a concrete vibrator, including a shaft assembly with a casing.

FIG. 1A is a perspective view of a concrete vibrator including a shaft assembly with a casing.

FIG. 2 is a perspective view of another device, such as a transmission assembly for a seed meter drive, including a flexible shaft assembly with a casing.

FIG. 3 is a side view of the casing as shown in FIG. 1, 1A or 2.

FIG. 4 is an end view of the casing as shown in FIG. 3.

FIG. 5 is an enlarged end view of the casing as shown in FIG. 3

FIG. 6 is a side view of an existing casing with portions of layers removed to illustrate the construction of the existing casing.

FIG. 7 is a side view of another existing casing with portions of layers removed to illustrate the construction of the existing casing.

FIGS. 8A-8C are views of an alternative construction of a casing as shown in FIG. 1, 1A or 2.

FIGS. 9A-9C are views of another alternative construction of a casing as shown in FIG. 1, 1A or 2.

FIGS. 10A-10C are views of yet another alternative construction of a casing as shown in FIG. 1, 1A or 2.

FIGS. 11A-11C are views of a further alternative construction of a casing as shown in FIG. 1, 1A or 2.

FIGS. 12A-12D are views of another alternative construction of a casing as shown in FIG. 1, 1A or 2.

FIGS. 13A-13D are views of a liner of the casing of FIGS. 12A-12D.

FIGS. 14A-14D are views of the casing of FIGS. 12A-12D illustrated as part of a flexible shaft assembly as shown in FIG. 2.

### DETAILED DESCRIPTION

Before any independent embodiments are explained in detail, it is to be understood that the disclosure is not limited in its application to the details of construction and the arrangement of components set forth in the following description or illustrated in the following drawings. The disclosure is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

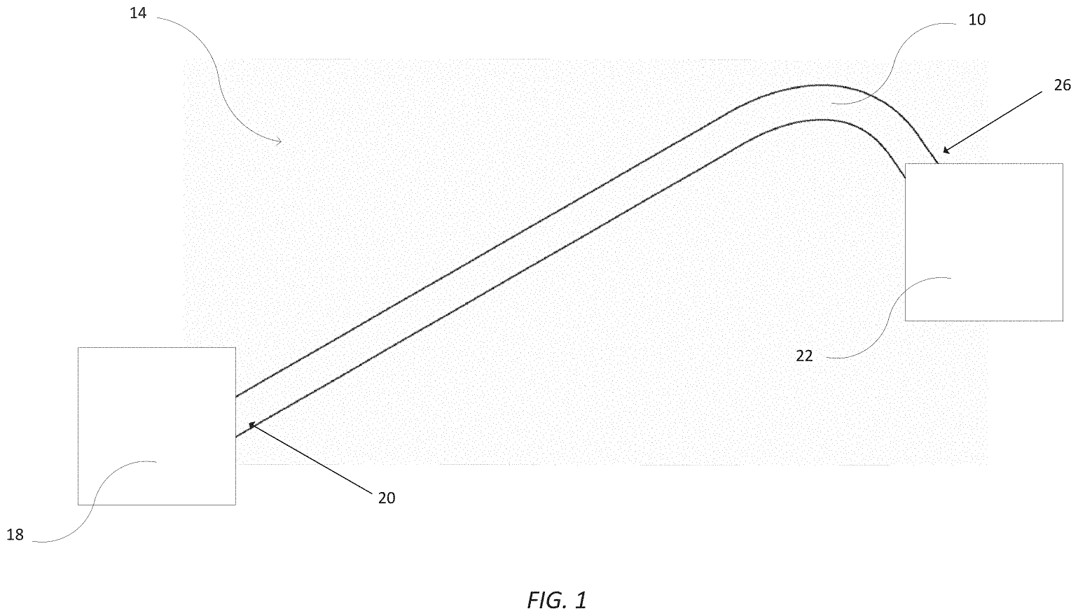

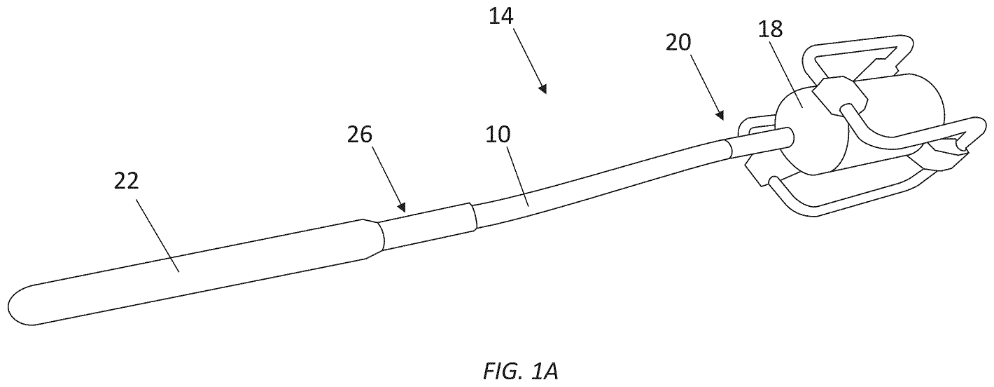

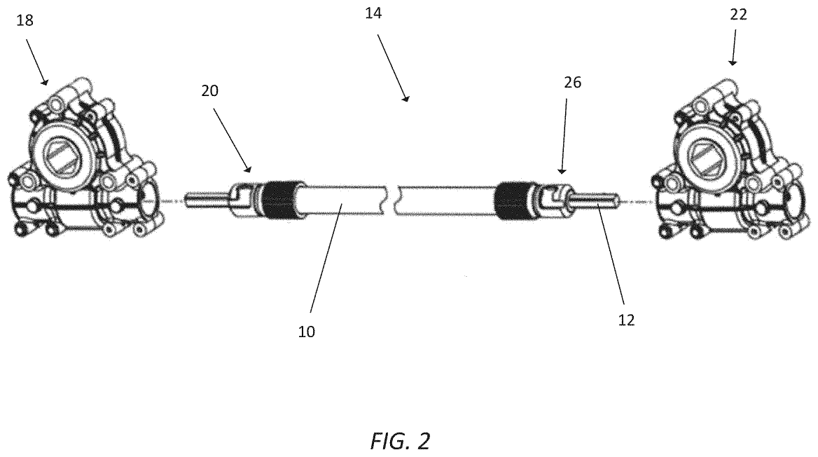

In general, the present disclosure relates to a casing 10, 210, 310, 410, 410′, 510 for, as illustrated, supporting a shaft 12 (see FIG. 2) of a shaft assembly for use in for a machine, a tool, a device, such as, for example, a concrete vibrator 14 (see FIG. 1), agricultural equipment 14A (e.g., a seeder (see FIG. 2)), a valve control device, a power tool, an outdoor tool, etc. Such a casing 10 may be used as a tube, pipe, conduit, etc. The casing 10, 210, 310, 410, 410′, 510 may be used, with or without a shaft 12, in agricultural, vehicular, industrial, medical, construction or other applications.

Generally, in illustrated constructions, the shaft 12 connects, at its opposite ends, a first unit (e.g., a power unit 18) to a second unit (e.g., a powered unit 22). In some embodiments (see FIGS. 1-2), the power unit 18 includes a drive unit, a motor (e.g., an electric motor (DC (battery-powered), AC), a gas (or other fuel) engine, etc.), etc., engaging a first end 20 of the casing 10 and the first end of the shaft 12. In such embodiments, the powered unit 22 includes a driven mechanism (e.g., a vibrating head, a seed meter, a cutting unit, etc., depending on the type of machine, tool or device) engaging the other end 26 of the casing 10. In such embodiments, the casing 10 supports the drive shaft 12 to transmit output (e.g., rotary motion) from the power unit 18 to the powered unit 22.

With reference to FIG. 1A, the casing 10 is used in a shaft assembly for a concrete vibrator 14. The first end 20 of the casing 10 engages a power unit 18 (as shown, a motor). The second end 26 of the casing 10 engages a powered unit 22—a vibrating head configured to create vibrations in wet concrete or another medium to assist in the setting process. The shaft 12 (not shown) transmits drive force from the motor to the vibrating head.

With reference to FIG. 2, the casing 10 is used in a seed meter drive assembly 14. The first end 20 of the casing 10 engages to a power unit 18—a first transmission receiving a drive input from a tractor (not shown). The second end 26 of the casing 10 engages a powered unit 22—a second transmission operable to drive a seed meter (not shown). The shaft 12 transmits rotary drive motion from the tractor to the seed meter.

In other embodiments (not shown), the power unit 18 includes a power source, such as a battery pack, at the first end 20 (e.g., on a battery support interface). In such embodiments, the powered unit 22 includes a drive mechanism, such as an electric motor, powered by the power source and the driven mechanism, at the second end 26. Also, in such embodiments, the casing 10 may support conductors (e.g., electrical wiring) to transmit electrical power through the casing 10 between the units 18, 22.

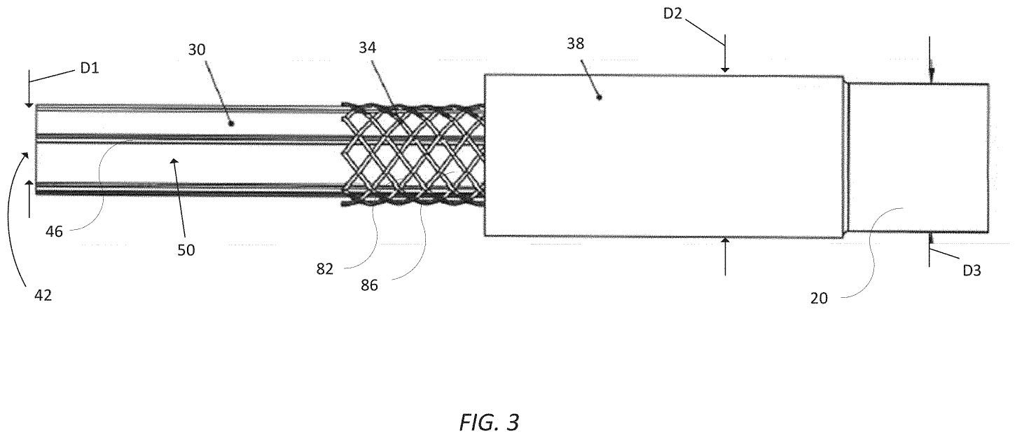

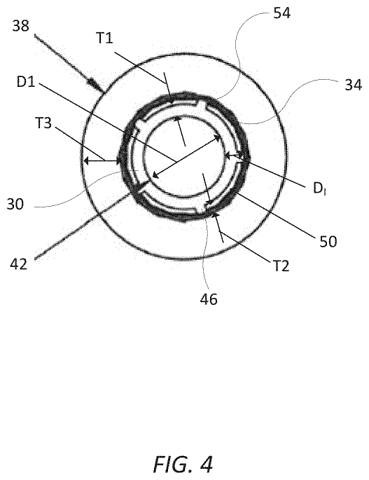

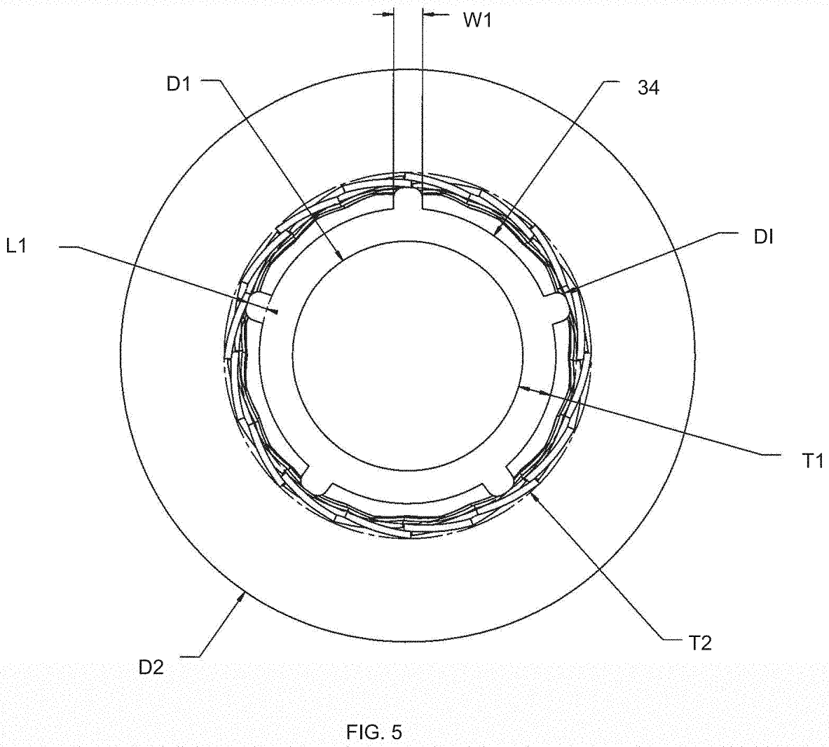

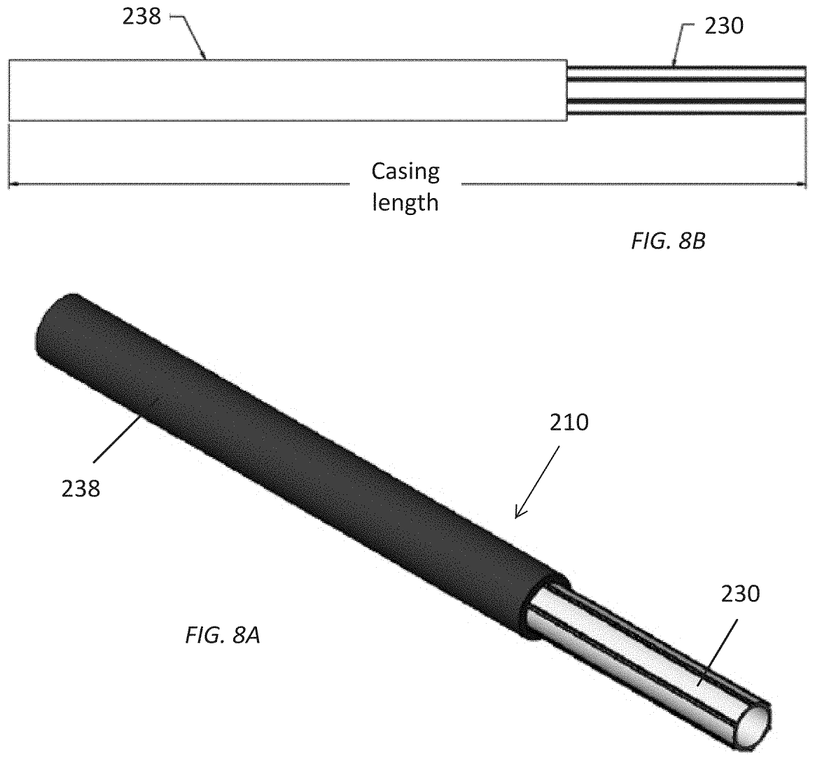

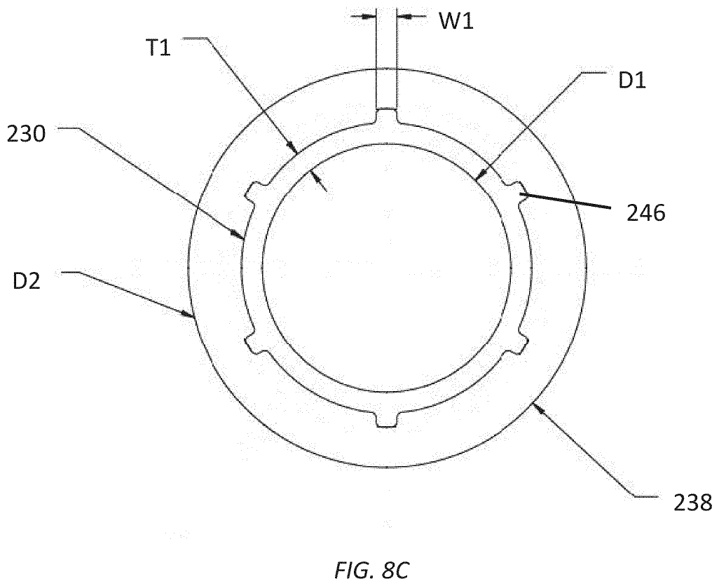

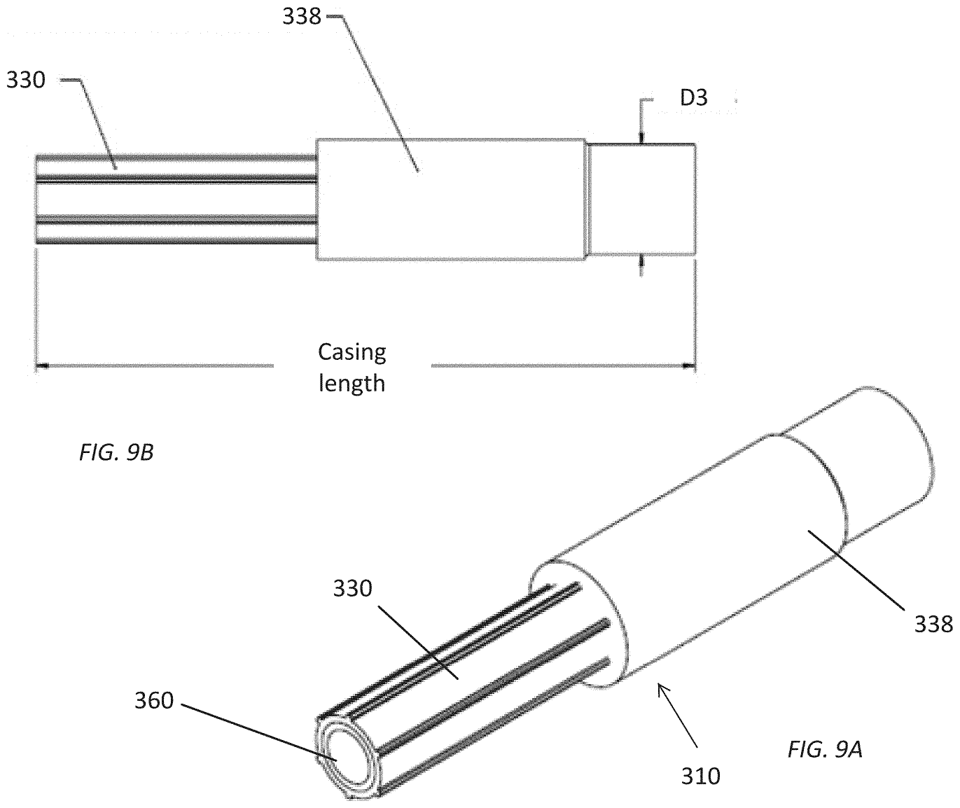

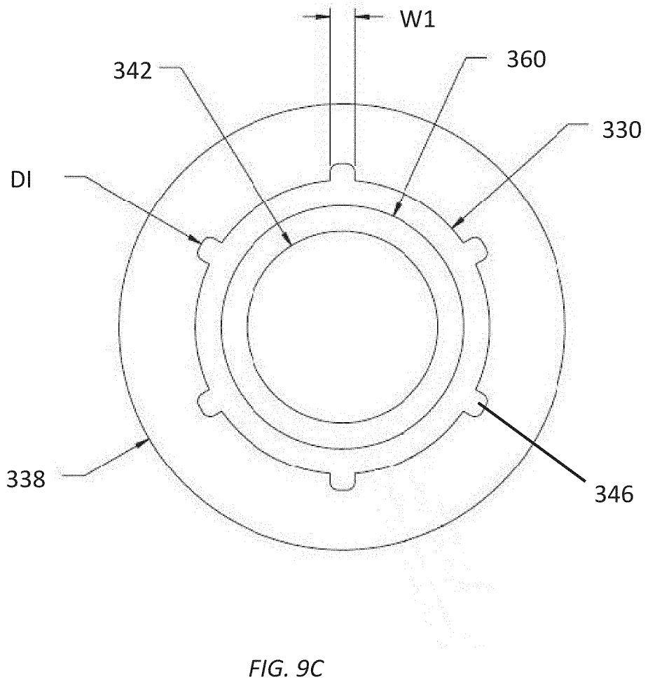

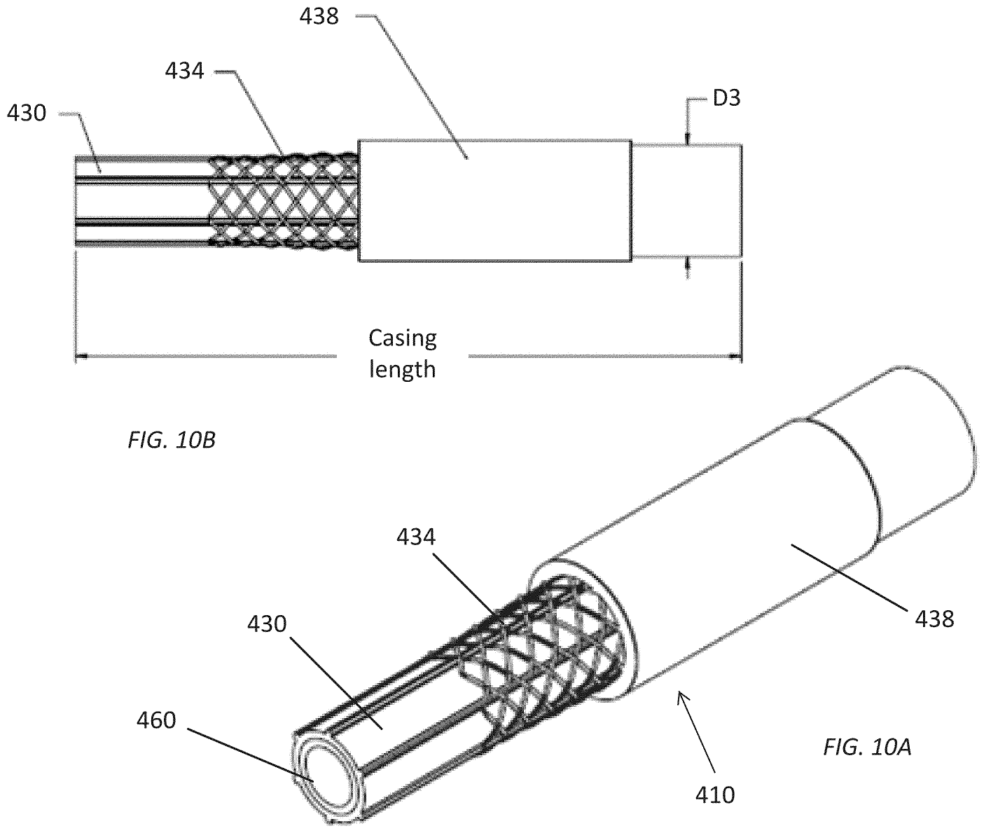

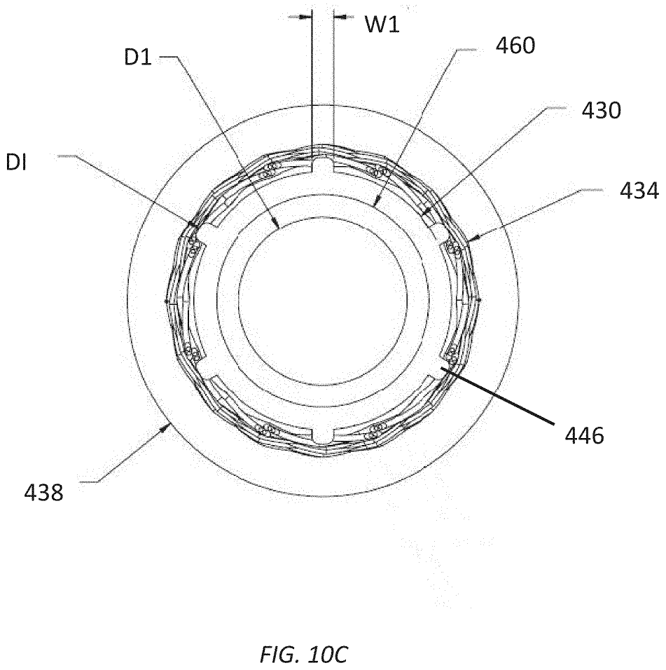

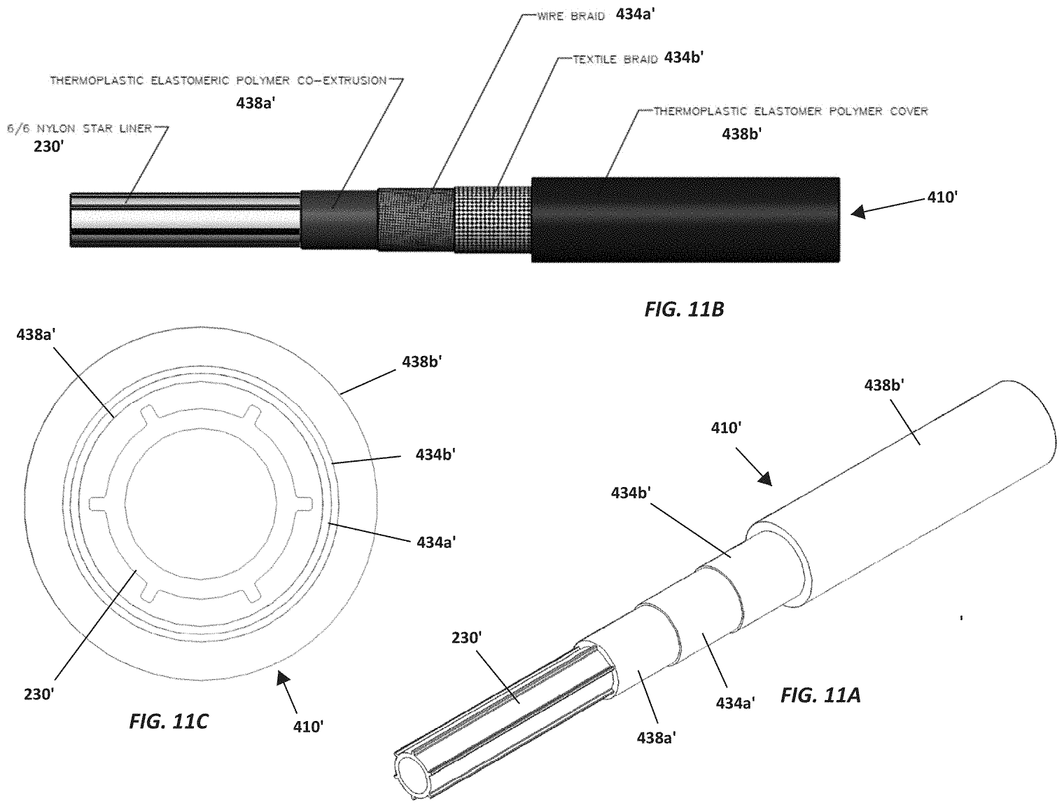

With reference to FIGS. 3-5, the casing 10 generally includes an inner tube or liner 30, an intermediate braided layer 34, and an outer tube or cover 38. In other constructions, the casing 10 may include fewer layers (see, e.g., FIGS. 8A-8C and 11A-11C), more layers (see, e.g., FIGS. 10A-10C) or different layers (see, e.g., FIGS. 9A-9C).

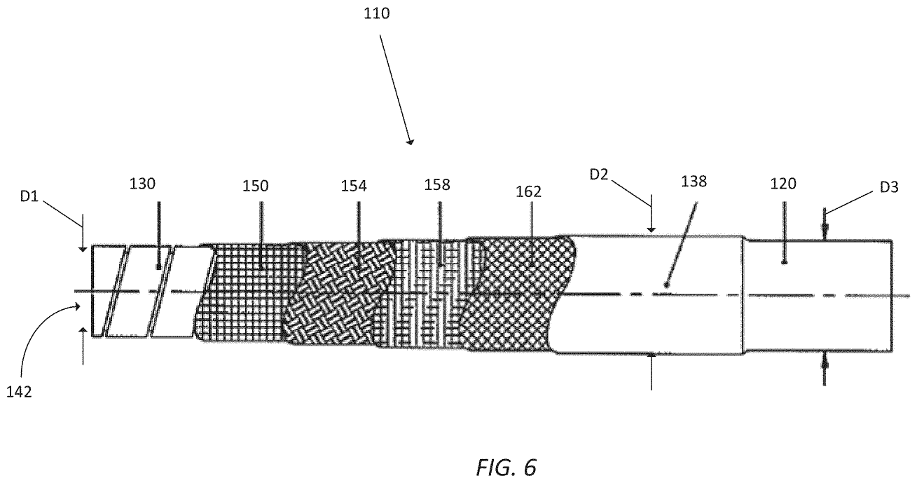

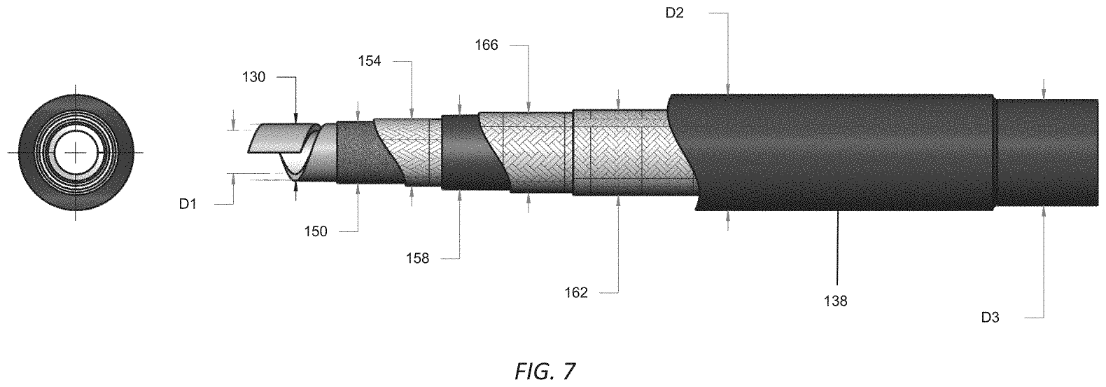

The casing 10 may replace the existing casings 110 described above and shown in FIGS. 6-7. As such, the casing 10 has similar dimensions—a central passage 42 with an inner diameter D1 of between about 0.425 in. and about 0.45 in. (e.g., 0.44 in. as illustrated), an outer diameter D2 of between about 0.95 in. and about 1.15 in. (e.g., about 1.09 in.), a reduced interface diameter D3 of between about 0.95 in. and about 1.05 in. (1.00 in. as illustrated), and a standard thickness between the inner surface of the liner 30 and the outer surface of the cover 38, at D2, between about 0.30 in. to about 0.35 in. (e.g., about 0.33 in. as illustrated) and, at D3, between about 0.27 in. to about 0.30 in. (e.g., about 0.28 in. as illustrated). It should be understood that, in other constructions and/or for other applications, one or more dimensions of the casing 10 may be different.

The liner 30 includes a body with a wall defining the central passage 42 with diameter D1 extending along its length. The illustrated passage 42 has a substantially circular cross-sectional shape; however, in other embodiments (not shown), the passage 42 may have a different cross-sectional shape (e.g., rectangular, polygonal, etc.). In embodiments in which the movable shaft 12 is supported in the passage 42, the inner surface of the body acts as a bearing surface. In other embodiments, the passage 42 itself may act as a pipe or conduit.

The illustrated liner 30 also includes a number of legs 46 (e.g., five shown) formed integrally with the body. Spaces 50 (e.g., five shown) are defined between adjacent legs 46. The illustrated legs 46 are spaced equally about the central axis and extend radially outwardly from and axially along the outer surface of the body. Each leg 46 has a substantially equal length L1 between the outer surface of the body and an associated radial outer end 54 and a substantially equal circumferential width W1. As illustrated, the outer radial end of each leg 46 is rounded.

The ends 54 of the legs define an imaginary circle having a diameter D_{I} providing an outer diameter of the liner 30. A total thickness of the liner 30 is defined between the inner surface of the body wall and the diameter D1. In other words, the total thickness of the liner 30 is equal to the thickness T1 of the body wall and the length L1 of a leg 46. In the illustrated construction, the total thickness of the liner 30 is between about 30% and about 37% of the thickness of the casing 10 (e.g., about 31.09% at D2 and about 36.06% at D3).

In the illustrated construction, the wall of the body has a thickness T1 of between about 19% and about 23% of the thickness of the casing 10 (e.g., about 19.30% at D2 and about 22.38% at D3). Each illustrated leg 46 has a length L1 of between about 11% and about 14% of the thickness of the casing 10 (e.g., about 11.94% at D2 and about 13.85% at D3). As shown, the thickness T1 of the body is greater than the length L1 of each leg 46 and also greater than the circumferential width of each leg 46.

In other constructions (not shown), the liner 30 may include fewer than or more than five legs 46 defining a corresponding number of spaces 50. Also, in other constructions (not shown), the construction, dimensions, position, etc. of the leg(s) 46 may be different. For example, the leg(s) 46 may not be equally spaced, may be oriented non-radially relative to the axis of the liner 30, etc. In addition, the leg(s) 46 may have a different length and/or thickness (e.g., the same as or greater than the thickness T1).

The illustrated spaces 50 are equally sized and equally circumferentially spaced around the body. Each space 50 has a cross-sectional area less than that of the central passage 42. The spaces 50 have a greater angular extent proximate the ends 54 of the legs 46 and taper toward the body. In other constructions (not shown), the spaces 50 may have a different size/spacing. For example, the outer spaces 50 may not taper, and, instead, the legs 46 may taper.

The illustrated legs 46, and, as a result, the spaces 50, extend along the length of the liner 30. In other constructions (not shown), the length of the leg(s) 46 may be different than the length of the body. Also, the leg(s) 46 may not be continuous along the length of the casing body.

The illustrated liner 30 (the body and the legs 46) are formed by extruding from a plastic composite. In some embodiments, the liner 30 may be formed from nylon 66, polyethylene, polypropylene, etc.

The casing 10 further includes a braided layer 34 having a thickness T2 of between about 7% and about 10% the thickness of the casing 10 (e.g., about 7.96% at D2 and about 9.24% at D3). Strands of material 82 are braided to form the braided layer 34. The braided layer 34 is coaxial with the liner 30 along the central axis. The illustrated braided layer 34 has a length substantially the same as the length of the liner 30. In other embodiments (not shown), the lengths of the braided layer 34 and of the liner 30 may be different.

Spaces 86 are formed between the braided material 82. The number and size of the spaces 86 in the braided layer 34 depend on how tightly the material 82 is braided. With a tight braid, the spaces 86 are smaller; with a loose braid, the spaces 86 are larger.

The braided layer 34 is disposed on the legs 46 such that the inner surface of the braided layer 34 engages with the end 54 of each leg 46. As discussed below, the braided layer 34 may deform into the spaces 50 even to the extent (not shown) that portions of the braided layer 34 engage with the outer surface of the liner body.

In the illustrated embodiment, the braided layer 34 is formed through twisting, braiding, plaiting, etc., the material 82. The material 82 may be formed from a metal (e.g., tin-plated copper, nickel-plated copper, aluminum, nickel, etc.).

The cover 38 has a thickness T3 of between about 58% and about 66% of the thickness of the casing 10 (e.g., about 64.93% at D2 and about 59.32% at D3). As illustrated, the cover thickness T3 is greater than the liner thickness T1; however, in other embodiments (not shown), the thicknesses T1, T3 may be the same or the thickness T1 may be greater than the thickness T3. The illustrated cover 38 has a length substantially the same as the liner 30. In other embodiments, the lengths of the cover 38 and the liner 30 may be different.

The cover 38 has a substantially circular cross-sectional shape; however, in other embodiments (not shown), the cover 38 (at least the outer surface) may have a different cross-sectional shape (e.g., rectangular, polygonal, etc.). In the illustrated construction, the cover 38 is coaxial with the liner 30.

The cover 38 is disposed on the braided layer 34 such that the inner surface of the cover 38 engages the outer surface of the braided layer 34. Material of the cover 38 may enter and fill spaces 86 in the braided layer 34. The cover 38 may compress material 82 of the braided layer 34 into spaces 50 between the legs 46.

The cover 38 may be formed by extruding from a thermoplastic elastomer (TPE). In some embodiments, the cover 38 may be formed from styrenics, copolyesters, polyurethanes, polyamides, etc.

The illustrated casing 10 is manufactured in a continuous process. The liner 30 is formed (e.g., extruded) with the body and the legs 46 being integrally. Material 82 of the braided layer 34 is braided over the formed section of the liner 30. The cover 38 is then formed (e.g., extruded) over the formed section of the braided layer 34 and the liner 30. It should be understood that, for certain aspects, a different and/or non-continuous (e.g., batch process) may be used to form the casing 10.

In the illustrated construction, forming the cover 38 causes the material of the cover 38 to enter spaces 86 in the braided layer 34 and material 82 of the braided layer 34 to enter spaces 50 in the liner 30. As a result, the components are “locked” together.

Once the cover 38 is formed over the braided layer 34 and the liner 30, a casing blank is formed. The casing blank may be cut to provide a casing 10 of selected length for an application (e.g., a machine, a tool, a device, etc.). Because the casing 10 is cut from the continuous blank, there is little to no waste.

The construction of the liner 30 (e.g., material, passage diameter D1, wall thickness T1, number and size (thickness, length) of the legs 46, etc.), the selection of the material 82 and the construction of the braided layer 34 (e.g., braid pattern, angle, spacing, etc.), and/or the construction of the cover 38 (e.g., material, outer diameters D2, D3, wall thickness T3, etc.) may be determined in view of the application for the casing 10 (e.g., the type of machine, tool, device, power unit 18, powered unit 22, etc.), operational characteristics (e.g., flexibility, rigidity, wear tolerance, etc.), material availability and cost, etc. The construction of the components of the casing 10 may be easily adjusted (e.g., change leg dimensions, braid spacing, etc.) during manufacturing to accommodate changes in these and other factors.

As discussed above, the liner 30 occupies a significant portion (over 30%) of the total thickness of the casing 10. Further, the liner 30 includes multiple elements (the wall and the legs 46) each occupying a relatively large portion (at least 10% and up to about 20%) of the total thickness of the casing 10. As a result, the construction of the liner 30 itself can be modified to make significant changes to the resulting casing 10 without affecting other components (the braided layer, the cover 38) of the casing 10. The number, size, position, etc. of the leg(s) 46 the relative construction of the wall and the leg(s) 46 may be modified as necessary or desired.

In addition, because of the limited number of components in the casing 10 (three components—the liner 30, the braided layer 34, and the cover 38) compared to the existing casings 110 with six or seven components, modifications may be made more easily to more than one component (e.g., to the liner 30 and to the cover 38) with limited impacted on the other component (the braided layer 34).

As previously mentioned, to provide an interface (e.g., to the units 18, 22) at ends 20, 26 of the cover 38, the outer diameter may be reduced (e.g., by grinding) to the smaller diameter D3. The reduction in the outer diameter of the ends 20, 26 may aid in the ends coupling to the units 18, 22, respectively. For example, as shown in FIG. 2, a connector assembly may be added to each end 20, 26 to interface with the structure of the units 18, 22 (e.g., transmission units).

Because the cover 38 of the casing 10 includes relatively more material than the cover 138 of the existing casings 110 (at D2, more than 60% of the thickness of the casing 10 compared to less than 52% of the casing 110 in FIG. 6 and less than 44% of the casing 110 in FIG. 7), the cover 38 has more material that can be removed before reaching the braided layer 34, and the minimum diameter D3 to which the outer surface of the ends 20, 26 can be ground is increased in the casing 10.

FIGS. 8A-8C illustrate an alternative construction of a casing 210. The casing 210 is similar to the casing 10 described above and shown in FIGS. 1-7, and common elements have the same reference number in the “200” series.

The casing 210 includes an inner tube or liner 230 (e.g., formed of nylon) and an outer tube or cover 238 (e.g., formed of TPE, thermoplastic vulcanizates (TPV; such as Santoprene™, manufactured by ExxonMobil® Chemical)). The illustrated casing 210 does not include any intermediate layers (e.g., the braided layer 34 of the casing 10). In other words, in the casing 210, the cover 238 directly contacts an external surface of the liner 230 (e.g., at least the outer surface of the legs 246). The material of the cover 238 fills the spaces between the legs 246 and directly contacts the outer surface of the body of the liner 230. The liner 230 and the cover 238 are co-extruded.

In the illustrated construction, the liner 230 defines a larger inner diameter D1 of between about 0.465 in. to about 0.475 in. (e.g., about 0.472 in.) than the liner 30. The illustrated outer cover 238 has a smaller outer diameter D2 of between about 0.75 in. and about 0.76 in. (e.g., about 0.755 in.) than the outer cover 38. The casing 210 has a standard thickness between the inner surface of the liner 230 and the outer surface of the cover 238, at D2, between about 0.135 in. to about 0.145 in. (e.g., about 0.142 in. as illustrated). The smaller diameter/thickness casing 210 may be used in applications which do not require a braided layer, such as agricultural (seeder) or industrial applications.

In the illustrated construction, the total thickness of the liner 230 is between about 40% and about 50% of the thickness of the casing 210 (e.g., about 46.29%). The illustrated cover 238 has a thickness of between about 50% and about 60% of the thickness of the casing 210 (e.g., about 53.71%).

In the illustrated construction, the wall of the body of the liner 230 has a thickness T1 of between about 25% and about 30% of the thickness of the casing 210 (e.g., about 27.56%). Each illustrated leg 246 has a length L1 of between about 15% and about 20% of the thickness of the casing 210 (e.g., about 18.73%). As shown, the thickness T1 of the body is greater than the length L1 of each leg 246; however, as illustrated, the thickness T1 of the body is about the same as the circumferential width W1 of each leg 246.

FIGS. 9A-9C illustrate an alternative construction of a casing 310. The casing 310 is similar to the casings 10, 210 described above and shown in FIGS. 1-7 and 8A-8C, respectively, and common elements have the same reference number in the “300” series.

The casing 310 generally includes an inner tube or liner assembly, formed of a liner member 330, similar to the liners 30, 230, described above, and a tube member 360, and an outer tube or cover 338. The tube 360 has a substantially circular cross-section and defines the central passage 342 having an inner diameter D1. The outer surface of the tube 360 directly engages the inner surface of the liner member 330.

The illustrated liner assembly (the liner member 330 and the tube member 360) is co-extruded. In the illustrated construction, the liner member 330 and the tube 360 are formed of different materials (e.g., TPE and nylon, respectively).

The illustrated casing 310 does not include any intermediate layers (e.g., the braided layer 34 of the casing 10) between the cover 338 and the liner assembly. In other words, in the casing 310, the cover 338 directly contacts an external surface of the liner member 330 (e.g., at least the outer surface of the legs 346). The material of the cover 338 fills the spaces between the legs 346 and directly contacts the outer surface of the body of the liner member 330. The liner assembly and the cover 338 are co-extruded.

In the illustrated construction, the liner assembly (e.g., the tube member 360) defines a larger inner diameter D1 of between about 0.46 in. to about 0.47 in. (e.g., about 0.468 in.) than the liner 30. The illustrated outer cover 338 has a similar outer diameter D2 of between about 0.95 in. and about 1.15 in. (e.g., about 1.09 in.) as the outer cover 38. The casing 310 has a standard thickness between the inner surface of the tube member 360 and the outer surface of the cover 338, at D2, between about 0.305 in. to about 0.315 in. (e.g., about 0.311 in. as illustrated).

In the illustrated construction, the total thickness of the liner assembly is between about 50% and about 55% of the thickness of the casing 310 (e.g., about 53.38%). The illustrated cover 238 has a thickness of between about 45% and about 50% of the thickness of the casing 210 (e.g., about 46.62%).

In the illustrated construction, the tube member 360 has a thickness of between about 18% and about 22% of the thickness of the casing 310 (e.g., about 20.26%). As illustrated, the liner member 330 has a thickness of between about 30% and about 35% (e.g., about 33.12%) of the casing 310, with the wall of the body of the liner member 330 having a thickness T1 of between about 18% and about 22% (e.g., about 20.26%) and each illustrated leg 346 having a length L1 of between about 10% and about 15% of the thickness of the casing 310 (e.g., about 12.86%). As shown, the thickness T1 of the body of the liner member 330 and the thickness of the liner 360 is greater than the length L1 of each leg 346 and about the same as the circumferential width W1 of each leg 346.

FIGS. 10A-10C illustrate an alternative construction of a casing 410. The casing 410 is similar to the casings 10, 210, 310 described above and shown in FIGS. 1-7, 8A-8C and 9A-9C, respectively, and common elements have the same reference number in the “400” series.

The casing 410 generally includes an inner tube or liner assembly, formed of a liner member 430, similar to the liners 30, 230 and the liner member 330, described above, and a tube member 460, and an outer tube or cover 438. The illustrated liner assembly of the casing 410 is the same as the liner assembly of the casing 310 and has the same construction and dimensions.

In the illustrated construction, the liner assembly (e.g., the tube member 460) defines a larger inner diameter D1 of between about 0.46 in. to about 0.47 in. (e.g., about 0.468 in.) than the liner 30. The illustrated outer cover 438 has a similar outer diameter D2 of between about 0.95 in. and about 1.15 in. (e.g., about 1.09 in.) as the outer cover 38. The casing 410 has a standard thickness between the inner surface of the tube member 460 and the outer surface of the cover 438, at D2, between about 0.305 in. to about 0.315 in. (e.g., about 0.311 in. as illustrated).

The casing 410 includes a braided layer 434 disposed between the liner assembly and the cover 438, similar to the braided layer 34 described above and shown in FIGS. 1-7. In the illustrated construction, the total thickness of the liner assembly is between about 50% and about 55% of the thickness of the casing 410 (e.g., about 53.38%). The braided layer has a thickness of between about 8% and about 13% of the thickness of the casing 410 (e.g., about 11.25%). The illustrated cover 438 has a thickness of between about 30% and about 40% of the thickness of the casing 410 (e.g., about 35.37%).

The illustrated casing 410 is manufactured in a continuous process. The liner member 430 is formed (e.g., extruded) with the body and the legs 46 being integrally and is co-extruded with the liner 460. Material of the braided layer 434 is braided over the formed section of the liner assembly. The cover 438 is then formed (e.g., extruded) over the formed section of the braided layer 434 and the liner assembly. It should be understood that, for certain aspects, a different and/or non-continuous (e.g., batch process) may be used to form the casing 410.

In other constructions (see FIGS. 11A-11C) of a casing 410′, the braided layer 434′ and the cover 438′ may be formed as an assembly. For example, a first cover layer 438a′ may be formed over inner components of the casing (e.g., over the liner 30, 230 or the liner assembly). A braided layer 434′ (illustrated as a wire braid 434a′ and a textile braid layer 434b′) may be braided over the first cover layer 438a′, and a second cover layer 438b′ may be formed over the braided layer 434′. The cover layers 438a′, 438b′ may encapsulate the braided layer 434′.

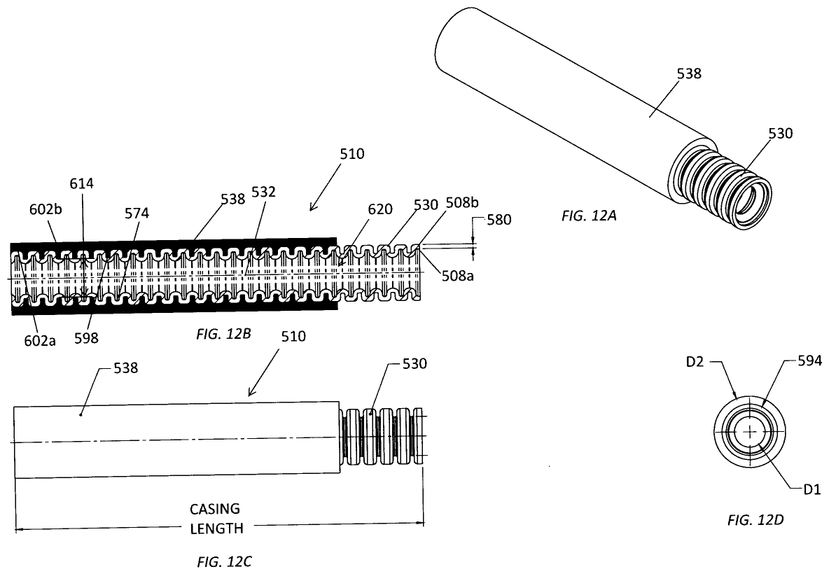

FIGS. 12A-12D illustrate an alternative constructive of a casing 510. The casing 510 is similar to the casings 10, 210, 310, 410, 410′ described above and shown in FIGS. 1-7, 8A-8C, 9A-9C, 10A-10C, and 11A-11C, respectively, and common elements have the same reference number in the “500” series.

The illustrated casing 510 generally includes an inner tube or liner 530 and an outer cover 538. In the illustrated construction, the tube 530 includes a corrugated tube with corrugations 564 extending circumferentially around its axis 532. The corrugations 564 include a peak 568, located furthest from the axis 532, and a trough 572, located closest to the axis 532. In the illustrated construction, the section of each corrugation 564 extending to the peak 568 corresponds to a “leg” of the tube 530.

As shown in FIG. 13B, the corrugations 564 have, measured along the axis 532, a peak-to-peak spacing 576a, between the centers of adjacent peaks 568, and a trough-to-trough spacing 576b, between the centers of adjacent troughs 572. On the outer surface 580b, each peak 568 has a radial height 568a (and each trough 572 has a radial depth 572a) measured between the bottom of a trough 572 and the top of the peak 568. Each peak 568 also has an axial width 568b between its axial sides. Each trough 572 has an axial width 572b between the sides of adjacent peaks 568. As illustrated, the peaks 568 and the troughs 572 have a generally flat outer surface (between about 40% to about 50% of the associated width 568b, 572b (e.g., at least about 47% of the peak width 568b and at least about 35% of the trough width 572b)).

The troughs 572 provide grooves 574 on the exterior of the tube 530. Each groove 574 is defined radially between the bottom of the trough 572 and the outer diameter 594 of the tube 530 (at the top of the peaks 568) and axially between the sides of adjacent peaks 568. As discussed below, the grooves 574 provide a structure for the outer cover 538 to engage.

The tube 530 has a wall thickness 580 between the inner and outer surfaces 580a, 580b. The wall thickness 580 is determined based on, for example, the loading characteristics and desired factor of safety applied to the casing 510 and will generally be sufficient to resist crushing or expansion and other loading conditions to avoid plastic deformation of the tube 530 during use.

In the illustrated construction, the inner surface 580a of the tube 530 is generally curved along the peaks 568 and the troughs 572. A cavity 584 is provided beneath each peak 568. Each cavity 584 has a radial depth 572a measured between the inner surface of the peak 568 and the inner diameter D1 of the tube 530 and an axial width 572b between the axial sides of adjacent troughs 572.

Each cavity 584 provides an annular volume for lubricant, grease or other fluids within the tube 530, for example, when used in a shaft assembly. Engagement of a shaft with the inner surface 580a of the troughs 572 inhibits flow from or closes each cavity 584 to contain the lubricant, reducing leakage along the shaft and from the casing 510. The cavities 584 cooperate to hold a significant amount of lubricant for the shaft assembly.

In the illustrated construction, structural features of the tube 530 (e.g., the heights/depths and widths of the peaks 568, troughs 572, grooves 574 and cavities 584, the spacing 576a, 576b, the wall thickness 580, etc.) are uniform along the axis 532; however, in other constructions (not shown), one or more structural features may be non-uniform along the length or along portions of the length of the casing 510.

As shown in FIG. 12B, the outer cover 538 has an interior surface 602a engaging, in the illustrated construction, the outer diameter 594 of the tube 530 (e.g., the top surface 580b of the peaks 568). The exterior surface 602b of the cover 538 provides the outer surface of the casing 510 and defines the outer diameter D2 of the casing 510. The cover 538 has a thickness between the surfaces 602a, 602b.

Annular ribs 598 project radially inwardly from the surface 602a and into the grooves 574 on the exterior of the tube 530. The ribs 598 mate with and substantially fill the grooves 574 and engage the surface 580b of the associated trough 572. Each rib 598 extends to a height corresponding to the trough depth 572a and providing an inner diameter of the cover 538 and has a width corresponding to the trough width 572b. In the assembled casing 510, engagement between the ribs 598 and the grooves 574 (and the peaks 568 in the spaces between the ribs 598) restricts relative movement (e.g., axial slipping) of the cover 538 and to the tube 530.

The construction of the casing 510 (e.g., dimensions, materials, etc. of the tube 530, the cover 538) can be changed or scaled according to the application of, the desired characteristics for, etc. the casing 510. For exemplary purposes, dimensions of the components and structure of the casing 510 are expressed as a ratio to a given dimension, such as the outer diameter D2 of the casing 510 (as illustrated, between about 0.900 in. and about 1.625 in. (e.g., about 1.090 in.)).

It should be understood that the below example ratios may be different in other embodiments of the casing 510. It should also be understood that, in other constructions, the outer diameter D2 of the casing 510 may be less than 0.900 in. or greater than 1.625 in. and other dimensions may be scaled accordingly and/or changed in view of the application, characteristics, etc. of the casing 510.

In some constructions, the outer diameter 594 of the tube 530 is between 50% and about 95% (e.g., about 78%) of the outer diameter D2 (as illustrated, between about 0.840 in. and about 0.850 in. (e.g., 0.846 in.)). The inner diameter D1 of the tube 530 is between about 28% and about 53% (e.g., about 43%) of the outer diameter D2 (as illustrated, between about 0.455 in. and about 0.475 in. (e.g., about 0.465 in.)). The wall thickness 580 of the tube 530 is between about 3% and about 8% (e.g., about 6%) of the outer diameter D2 (as illustrated, between about 0.060 in. and about 0.065 in. (e.g., about 0.063 in.)).

In the tube 530, the peak-to-peak spacing 576a and the trough-to-trough spacing 576b is between about 15% and about 30% (e.g., about 23%) of the outer diameter D2 (as illustrated, between about 0.245 in. and about 0.260 in. (e.g., about 0.255 in.)). The peak height 568a (and the trough depth 572b and the groove depth 574b) is between 7% and about 15% (e.g., about 12%) of the outer diameter D2 (as illustrated, between about 0.120 in. and about 0.130 in. (e.g., about 0.126 in.)). The peak width 568b is between about 11% and about 22% (e.g., about 17%) of the outer diameter D2 (as illustrated, between about 0.185 in. and about 0.195 in. (e.g., about 0.188 in.)), and the trough width 572b is between about 4% and about 8% (e.g., about 6%) of the outer diameter D2 (as illustrated, between about 0.065 in. and about 0.070 in. (e.g., about 0.067 in.)). The cavity depth 584a is between about 7% and about 15% (e.g., about 12%) of the outer diameter D2 (as illustrated, between about 0.120 in. and about 0.130 in. (e.g., about 0.126 in.)), and the cavity width 584b is between about 3% and about 8% (e.g., about 6%) of the outer diameter D2 (as illustrated, between about 0.060 in. and about 0.070 in. (e.g., about 0.065 in.)).

With respect to the cover 538, as mentioned above, the outer diameter D2 of the casing 510 and of the cover 538 is illustrated as being between about 0.900 in. and about 1.625 in. (e.g., about 1.090 in.)). The diameter of the cover 538 at the inner surface 602a of between about 0.840 in. and about 0.850 in. (e.g., about 0.846 in.), and the thickness of the cover 538 between the surfaces 602a, 602b is between about 7% and about 14% (e.g., about 12%) of D2 (as illustrated, between about 0.120 and about 0.125 in. (e.g., about 0.122 in.)).

The height of the ribs 598 corresponds to the groove depth 574b and is between 7% and about 15% (e.g., about 12%) of the outer diameter D2 (as illustrated, between about 0.120 in. and about 0.130 in. (e.g., about 0.126 in.)). The width of the ribs 598 corresponds to the groove width 574b is between about 4% and about 8% (e.g., about 6%) of the outer diameter D2 (as illustrated, between about 0.065 in. and about 0.070 in. (e.g., about 0.067 in.)). The ribs 598 and grooves 574 provide an amount of radial overlap of the tube 530 and the cover 538, resisting relative axial movement of these components.

The ribs 598 define an inner diameter of the cover 538 of between about 36% and about 67% (e.g., about 54%) of the outer diameter D2 (as illustrated, about 0.590 in. and about 0.600 in. (e.g., about 0.594 in.)). The thickness of the cover 538 including the ribs 598 is between about 14% and about 28% (e.g., about 23%) of the outer diameter D2 (as illustrated, between about 0.240 in. and about 0.255 in. (e.g., about 0.248 in.)).

As mentioned above, dimensions of the casing 510 may be adjusted based on an application for, desired characteristics of the casing 510. For example, in an application in which crushing loads are not expected, the wall thickness 580 of the tube 530 may be reduced relative to the outer diameter D2 or the peak diameter 594.

In another example, the peak width 568b, trough width 572b, peak-to-peak spacing 576a, and trough-to-trough spacing 576b can be adjusted to increase or decrease the deformability of the entire casing 510. In one extreme, in a casing 510 having relatively a narrow peak width 568b, a wide trough width 572b, and a large peak-to-peak spacing 576a, the peaks 576 provide less rigidity to the casing 510 so that the casing 510 is more deformable state. In comparison, in a casing 510 having a moderate peak width 568b, a moderate trough width 572b, and a moderate peak-to-peak spacing 576a, the peaks 576 provide increased rigidity to the still deformable casing 510.

The tube 530 may be manufactured from a rigid, crush-resistant, flexible, abrasion-resistant, electrical-resistant, low-memory, and/or high-lubricity material. Such a material permits the casing 510 to be used in a variety of applications while providing structural integrity and durability of the casing 510. Such a tube 530 may be used in applications in which, for example, crush resistance, abrasion resistance, and electrical resistance are important, such as when passing live wiring through the tube 530. Flexibility and low-memory materials may allow the turning of the entire tube 530 along a minimum bend radius for a given application. The structure of the tube 530 combined with material selection may eliminate the need for a braided layer (such as the braided layer 434 of the casing 410), simplifying and reducing the cost of the casing 510 (for example, when compared to the casing 410).

In the illustrated embodiment, the tube 530 is formed of at least one of a polyamide (e.g., nylon 66), a polyacetal or polyoxymethylene (POM; e.g., acetal), or a thermoplastic vulcanizate (TPV; e.g., Santoprene™, manufactured by ExxonMobil® Chemical). In other embodiments, the tube 530 may be formed of at least one of a polyamide, a polyacetal or polyoxymethylene, or a thermoplastic vulcanizate and includes an additive. Such materials may promote various advantages of the tube 530, such as abrasion resistance, lubricity, use of additives, etc. Further, the density of the selected tube 530 may be low to limit the weight of the casing 510.

The illustrated cover 538 is formed of, for example, TPE, TPV, or other materials such as other rubbers and/or elastomers. Such materials may provide a relatively high coefficient of friction when compared to the materials selected for the tube 530 such that the cover 538 does not axially twist along the axis 532. Additionally, the relatively high coefficient of friction of the cover 538 on the exterior face 602b provides a high level of grip for holding the casing 510.

The illustrated casing 510, having substantially uniform structural features, can be manufactured in a continuous process with a mold conveyor. The mold conveyor includes multiple dies that press the tube 530 to create the grooves 574 and the cavities 584. Optionally, the same mold conveyor can extrude the outer cover 538 onto the tube 530, with the annular ribs 598 being in the grooves 574. The mold conveyor permits extrusion and corrugation of the entire casing 510 with one machine.

The continuous manufacturing process for the casing 510 permits bulk manufacturing of a casing blank, for example, in lengths of 2000 feet (ft.) to 3000 ft. After the bulk manufacturing, the casing blank, whether directly from the machine or from a spool, can be cut to length as required for the given application of the casing 510. Such bulk manufacturing reduces time and cost of manufacturing compared to manufacturing a casing to length. The bulk casing blank is easier to transport (e.g., rolled on a spool) and returns to a straightened configuration due to memory of the structure.

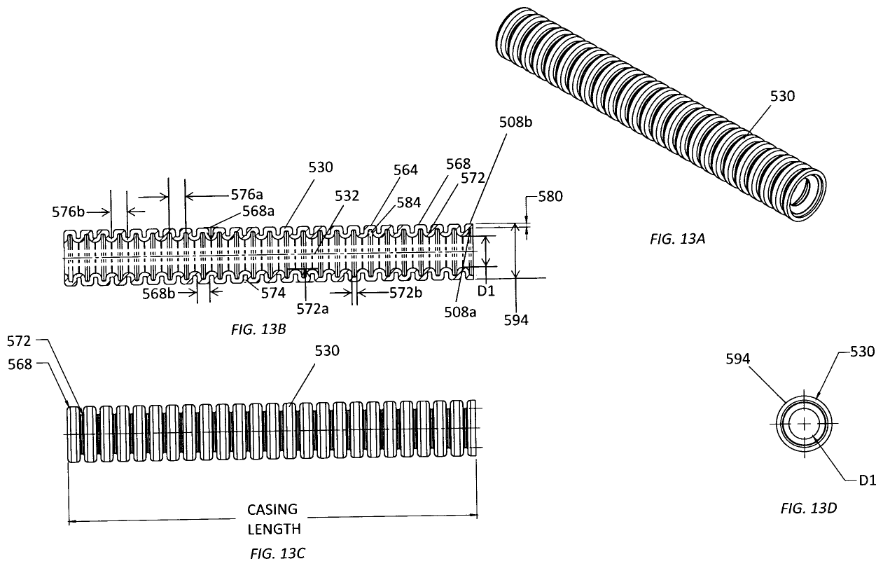

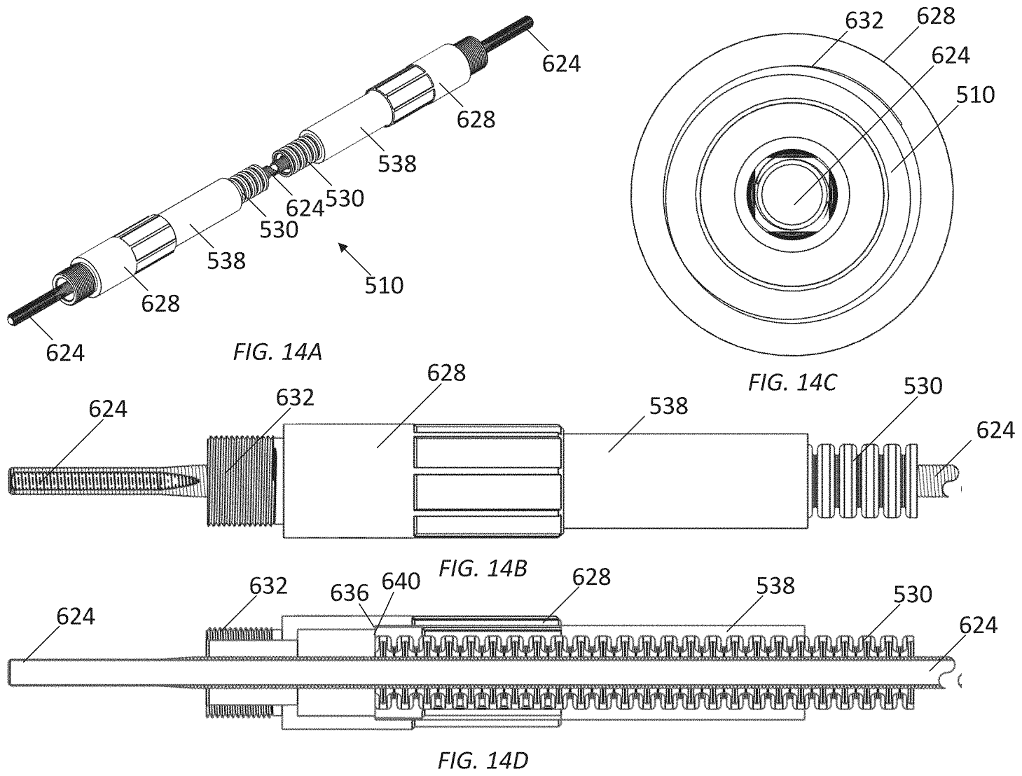

FIGS. 14A-14D illustrate the casing 510 as part of a shaft assembly supporting a shaft 624 within the volume 620. As illustrated, the shaft 624 includes an intermediate portion having a generally circular cross section and end portions with a non-circular (e.g., polygonal or square) cross section to transmit force between the units 18, 22. In the illustrated construction, the inner surface 580a at the inner diameter D1 provides a bearing surface for the shaft 624. Lubricant is provided and retained in the cavities 584.

As shown in FIGS. 14A-14D, a ferrule 628 is press-fit or otherwise connected to each end 20, 26 to connect the casing 510, for example, to the power unit 18 and to the powered unit 22. Each illustrated ferrule 628 includes a threaded surface 632, engageable with a complementary threaded portion (not shown) of the associated unit 18, 22, and a shoulder 636, abutting an end 640 of the casing 510.

In the illustrated casing 510, the interface between the corrugated tube 530, formed of plastic, and the cover 538, formed of softer TPE, may act as spine with compression disks to, for example, control the loop diameter (i.e., the minimum diameter a loop of the casing can be drawn under load) to protect the core (e.g., the shaft 624) from yielding; reduce, absorb vibration and other forces; support the core; eliminate the need for a braid layer and associated braiding operations, eliminate the need for additional materials (e.g., yarn, wire, etc.), reduce operating temperatures, etc. The illustrated corrugated plastic tube 530 may, for example, eliminate cast, improve uniform flexibility, provide more uniform distribution of lubricant between the core and the casing 510, increase crush resistance, etc. The illustrated TPE cover 538 may, for example, provide a soft grip feel to a user, provide abrasion resistance/durability for operating in industrial settings, etc. In view of the illustrated construction, the casing 510 may be lighter and less expensive to manufacture than other casings, such as the casing 10, 410.

The casing 10, 210, 310, 410, 410′, 510 can be used in a variety of applications. In some applications, as illustrated in FIGS. 1-2 and 13, a shaft 12, 624 is movably supported in the volume 620 defined by the casing 10, 210, 310, 410, 410′, 510 to transmit force between units 18, 22. In other applications (not shown), conductors (e.g., electrical wiring) extend through the volume 620 and operate to transmit electrical current through the casing 10, 210, 310, 410, 410′, 510, for example, from a battery power source to an electric motor. In still other applications (not shown), fluids, materials, etc. may be conveyed through the casing 10, 210, 310, 410, 410′, 510, directly through the volume 620 or through other components, such as conduits, pipes or tubes, extending through the volume 620.

It should be understood that features of one casing 10, 210, 310, 410, 410′, 510 may be incorporated into another casing. For example, the liner assembly in the casing 310, 410 may be incorporated into the casing 10, 210, 410′, 510. As another example, the corrugated tube 530 may be incorporated into another casing 10, 210, 310, 410, 410′.

One or more independent features and/or independent advantages of the invention may be set forth in the claims.

What is claimed is:

1. A casing comprising:
a liner defining a central passage and having a body and an outwardly-extending leg integrally formed with the body; and
a cover extending circumferentially about and axially along the liner.

2. The casing of claim 1, wherein the leg extends circumferentially about the body.

3. The casing of claim 2, wherein the leg is a first leg, and wherein the liner has a second leg extending circumferentially about the body and axially spaced from the first leg.

4. The casing of claim 3, wherein the liner includes a corrugated tube providing the body and the first leg and the second leg.

5. The casing of claim 1, wherein the leg extends axially along the body.

6. The casing of claim 5, wherein the leg is a first leg, and wherein the liner includes a second leg extending axially along the body and circumferentially spaced from the first leg.

7. The casing of claim 1, wherein the liner is provided by an assembly including a tube member defining the central passage and a liner member providing the body and the leg.

8. The casing of claim 1, further comprising a braided layer extending circumferentially about and axially along the liner, the braided layer engaging the leg, and wherein the cover extends circumferentially about and axially along the braided layer, the cover engaging the braided layer.

9. The casing of claim 8, wherein spaces are formed in the braided layer, material of the cover being in the spaces.

10. The casing of claim 1, wherein the liner includes a plurality of legs, each of the plurality of legs extending outwardly from the body.

11. The casing of claim 10, further comprising a braided layer extending circumferentially about and axially along the liner, the braided layer engaging the plurality of legs, and wherein a space is defined between adjacent ones of the plurality of legs, material of the braided layer being in each space.

12. The casing of claim 1, wherein the liner is extruded to include the body and the leg.

13. The casing of claim 12, further comprising a braided layer extending circumferentially about and axially along the liner, the braided layer being braided over the extruded liner.

14. The casing of claim 13, wherein the cover is extruded over the braided layer.

15. The casing of claim 1, wherein the cover engages the leg.

16. The casing of claim 15, wherein the liner is extruded to include the body and the leg, and wherein the cover is co-extruded with the liner.

17. The casing of claim 15, wherein the liner includes a plurality of legs, each of the plurality of legs extending outwardly from the body, and wherein a space is defined between adjacent ones of the plurality of legs, material of the cover filling each space.

18. The casing of claim 15, wherein the cover includes a first cover layer engaging the leg, wherein the casing further comprises a braided layer extending circumferentially about and axially along the first cover layer, the cover including a second cover layer extending about and axially along the braided layer.

19. A method of forming a casing, the method comprising:
forming a liner including defining a central passage and having a body and an outwardly-extending leg; and
extruding a cover circumferentially about and axially along the liner.

20. A drive assembly comprising:
a drive mechanism having a mechanical output;
a driven mechanism having a mechanical input; and
a shaft assembly including
a casing including
a liner defining a central passage and having a body and an outwardly-extending leg, and
a cover extending circumferentially about and axially along the liner, and
a shaft extending through the central passage, the shaft being connectable between the drive mechanism and the driven mechanism and operable to transmit the mechanical output to the mechanical input.
